(19) United States
(12) Patent Application Publication
(10) Pub. No.: US 2019/0019164 A1
(43) Pub. Date: Jan. 17, 2019

(54) Communication Method Utilizing Text Messaging to Enable the Synchronization of Voice Call Availability, Transmission and Connection

(71) Applicant: Gregory Thomas Malley, Los Altos Hills, CA (US)

(72) Inventor: Gregory Thomas Malley, Los Altos Hills, CA (US)

(21) Appl. No.: 15/651,959

(22) Filed: Jul. 17, 2017

(51) Int. Cl. G06Q 10/10; H04L 12/58

(52) U.S. Cl. CPC G06Q 10/1095; H04L 51/38; H04L 51/046; H04L 51/18

(57) ABSTRACT

A method in which text messaging is used to make voice transmissions via phone more efficient. The initiator of a phone call employs a dial pad which transmits a text message inquiring as to the availability of the recipient to take a voice call, rather than causing the phone of the recipient to ring. The text message provides a link to accept or schedule the call. If the recipient selects the ‘accepts’ link then the voice transmission is generated. If the recipient selects the ‘schedule later’ link, then prospective call times are displayed either in minutes or specific hours of the day. The originator of the call receives a text message specifying the preferred time or times. The originator of the call may confirm the time indicated or may select ‘schedule later’ and continue the process until both parties agree to a time for the voice call. As this process may be repeated, the invention involves an algorithm for queuing scheduled calls.

### TERMS

The term ‘call’ is used to mean a phone call. A phone call is a voice transmission.

Phone is meant to mean any communication device.

Caller is the person initiating the voice transmission.

Intended Recipient is the person for whom a voice call is intended.

The recipient is the party receiving a text message and with whom a voice call is requested.

A link is a ‘button’ encompassing wording, or is an icon which is displayed when the text is received.

Artificial Intelligence: An algorithm that learns.

### BACKGROUND OF THE INVENTION

Before the phone was invented if a person wanted to see someone, that person would go to their house and knock on the door. Or ring the doorbell.

Once the phone was invented, a call would be placed before going to visit someone.

Once the phone was available we would schedule a time to visit. You wouldn't just go to their home. That would seem odd. If you just showed up and knocked on the door without calling to schedule a time, think that was intrusive. They are probably busy.

They aren't just sitting around waiting for you to come over.

Before we had text messaging, well, we′d just call. Which is like knocking on the door without an appointed time to visit.

Prior to placing a call to someone we lack information regarding their availability. When we call someone the phone rings. The ring conveys no information. The ringing is just a noise. It just interrupts us. Unless we ignore it. Not an ideal state of affairs for the caller or the person called. There are lame attempts to deal with availability. If a person does text first, easy to miss the text message.

If one person wanted to visit another person prior to the invention of the telephone, the first party would go to the home of the second party and knock on an entry door. The first party may not necessarily have an appointment to visit, so they might be intruding.

The second party is not just waiting around for the first party to show up.

After the invention of the telephone, one party would call another party whom they wanted to visit before showing up at the second party's home and knocking on the door. That way the first party could make sure that their visit was timely and not an intrusion.

The caller selects a name out of a contact list and places a call. A person intending to make a call may also send a text message to schedule a call: ‘Can you take a call?’ While the caller is waiting for a reply, the caller sends out another inquiry as to someone else's availability to take a call. I may receive calls from both parties. One call may occur while a user is on the phone with the other party.

The current method used by the initiator of a voice transmission to connect with the intended recipient is often awkward. A call is originated by the initiator with no indication of the availability of the intended receivers. A phone call may be intrusive. A phone call may be disruptive; disruptive to the workflow of the person called; disruptive to conversations that are in process; functionally disruptive.

A person may email another party to schedule a phone call. There's no interactivity between the phone and email.

A user, the call initiator, may text a party whom they intend to call. The message sent asks, “Can you talk now?” The recipient of that text message may text back, “In 15 minutes”. The party who receives the request for a call in 15 minutes may or may not send a confirming message. They may assume that no reply means, ‘yes’. The party making the request does not have confirmation that the message has been read.

If the message has been read, that party making the request does have confirmation.

The person reading the text message may assume that no response means acceptance of the request. A recipient may also text a confirmation. This process is cumbersome.

And unsystematic. It is possible that the confirmed time conflicts with another scheduled call or other activity.

The user may become occupied doing something else and forget to call back.

Because one or both parties may get busy doing something else, time can pass without the call being made. Frequently, clarity is lacking as to which of the intended participants will make the call.

Without internal scheduling of the call integrated with auto-dialing, how will participants in the call remember that it's time to make the call?

Are they going to keep checking the time even though you get busy doing something else?

They might. But they might miss making the call.

And who is initiating the call now? Is the call initiator calling the intended call recipient in 10 minutes or . . . is the intended recipient calling the initiator?

In the state of the art, a phone call is initiated without knowledge of the intended recipient's availability to receive a call. Is the intended recipient on another call? Are they speaking with someone in person. Are they in a meeting? Are they otherwise occupied? In the state of the art, the communication made by the intended recipient to the initiator of the communication is after the voice transmission has been initiated. The noise of the phone ringing (or the vibrating, or flashing) is incumbent upon the intended recipient. The noise contains no information. The incoming call is not an inquiry regarding availability. The incoming call is a demand for attention. In the case of the current method, a call recipient may respond with a text response if the intended recipient is already on a call when the notification of the incoming call is received. Responses displayed in the event of an incoming call to a recipient on a call, may be ‘Can I call you later’, ‘I can't talk right now’ or other variants. Selecting one of these options tells the caller that a call cannot be accepted at this time. A method to schedule a time for a call is not offered. The incoming call is not synchronized with the availability of the intended recipient and initiator to take a call through an exchange of information regarding availability.

Typically, when a call is placed the recipient is not available because the recipient is otherwise engaged. A voice mail message is left for the recipient which they may listen to when they have time. Often the caller requests a return call. However, the return call often finds that the party who made the initial call and requests a return call is not available.

What happens is the call initiator calls the intended recipient. That person is busy so the call goes to voicemail. The person who called checks their voicemail and then places a call to the original caller. The original caller is now on a call so the person calling back now gets the original caller's voicemail.

In another example of the state of the art, an email exchange is used to schedule a call.

Each party must watch the clock as the designated time for the call approaches. He was doing the same. Quite distracting. During the call, one or more of the participants may receive an unscheduled call from someone else. Very distracting.

The state of the art is lacking in efficiency because the call occurs without pertinent information.

### BRIEF SUMMARY OF THE INVENTION

An object of the invention is to schedule a call with a text message.

The invention combines dialing and texting in a call. The invention combines dialing and texting to connect a caller and the intended call recipient. The invention combines dialing and texting to schedule calls. Unlike the scenario where the caller and call recipient exchange voice mail messages, both parties know the time of the call because the call is scheduled.

Before there was text messaging, the primary means people had to communicate was by calling. Which is like knocking on the door without an appointed time to visit.

A text message can be used by someone who wants to initiate a call to inquire of the intended recipient of the call as to their availability. A call without prior notification by text message can be problematic. An unscheduled call is intrusive. Because people are typically not waiting to receive an unscheduled call, a call is an interruption.

Now that we have texting, we can text before calling someone's phone with ‘ring, ring, ring’ until they answer. We can text before calling and inquire as to whether it is a good time to talk. And if it isn't, we can schedule a time to talk, which is confirmed by all participants.

In the context and in the case of the invention, a call begins with a data transmission.

A caller is the person initiating the voice transmission. A caller may be referred to as the Call Initiator or the Initiator.

Through this invention, machine learning can be applied to phone calling for the purpose of scheduling and managing phone calls.

The features of this invention can be activated by voice, touch screen or other means.

A call to a contact could be activated by voice instruction. The invention is a method utilizing algorithms to enable users to schedule calls dynamical.

In one form, the algorithm of the the invention functions as a ‘bot’, a software robot. Bots are applications that use artificial intelligence.

A user can schedule multiple calls such that calls are not scheduled at the same time.

Calls are placed in a queue without conflicting times.

The chat bot checks to see if the recipient has an application that provides the functionality for scheduling calls.

If not, a link is sent by text so that the recipient can obtain the application which provides this functionality.

One embodiment of the invention utilizes machine learning to assist in managing the making and receipt of our phone calls. The invention manages calling by use of chat bots.

With the use of the bot, the phone doesn't go ‘ring ring’. The chat bot instructs the phone to ask a question. When can we schedule a call? One scheduling option is for the call to go through now.

In the present invention, the initiator and recipient of an electronic voice transmission synchronize mutual availability by using the dial pad or contact list to exchange information in the format of data or as SMS communication.

In one embodiment of the present invention, the initiator and recipient of an electronic voice transmission use the dial pad or contact list to agree on a time for a phone call through an exchange of text messages.

In another embodiment, multiple, confirmed phone appointments are scheduled throughout the day, week or other time interval. The need to exchange voice mail messages is obviated by the described method.

In another embodiment, internal time clocks of devices used to make and receive voice transmissions are coordinated and synchronized.

In another embodiment, the internal time clock of a device used to make and receive voice transmissions is coordinated and synchronized with the internal time clocks of multiple devices.

In another embodiment, internal time clocks use specific time intervals.

In another embodiment internal time clocks use specific times of the day.

In another embodiment, messages sync between devices with compatible software applications.

In another embodiment, manual aspects of communicating before the initiation of a call are integrated into the call transmission. Icons are providing with links which enables users to choose to ‘accept’/‘schedule later’/‘decline’.

In one embodiment of the present invention utilizes artificial intelligence to assist in managing the making and reception of the phone calls. The present invention manages calling by the use of applications that use artificial intelligence, sometimes referred to as chat bots.

Intelligence is being applied to many aspects of today's phones; the camera, security system, applications of various kinds, but little is being done to apply intelligence to calling.

### BRIEF DESCRIPTION OF THE DRAWINGS

FIG. 1

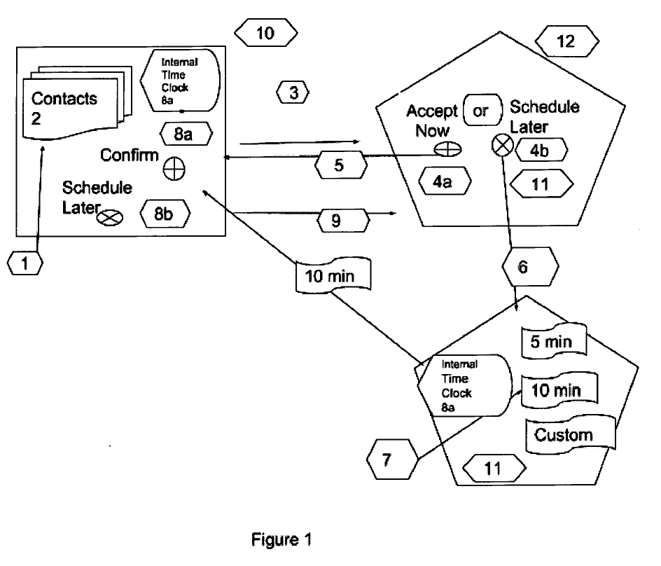

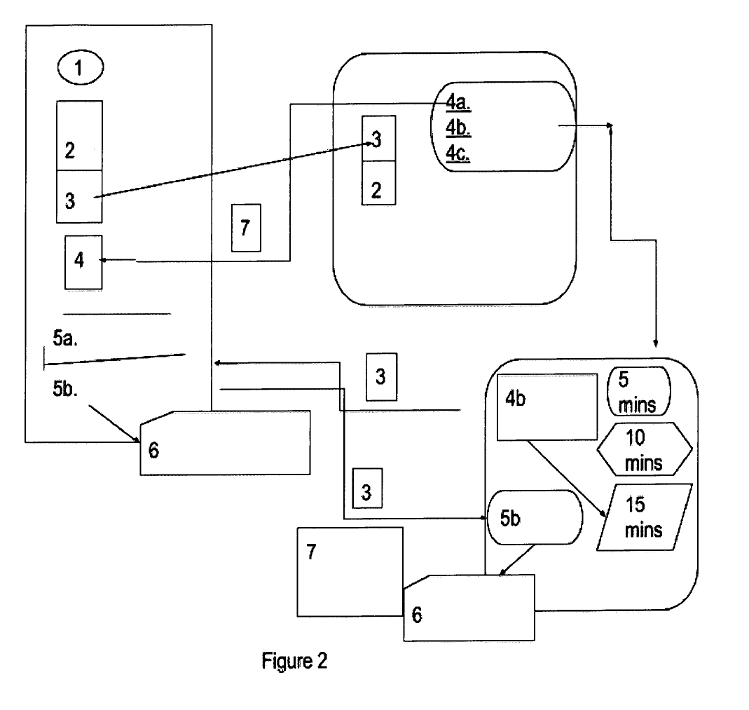

The contact list [2] from which a recipient [12] of a call is selected is internal to the phone [10]. The integrated dial pad, also internal to the phone, is used to call those not in the contact list.

A user [1] wishing to initiate a voice transmission selects a contact from their contact list [2]. Use of the contact list [2] (or dial pad, not illustrated) transmits a text message [3]. The recipient may elect ‘Accept Now’ [4a] or ‘Schedule Later’ [4b]. If the recipient selects ‘Accept Now’ [4a], then the voice transmission is initiated [5].

If the recipient selects ‘Schedule Later’ [4b], time intervals are displayed [6] from which the recipient can select [7] as well as an option to select ‘custom’ to input an alternate time or message.

The recipient may select [8a] to confirm the proposed time interval or select [8b] to display alternate time intervals (not displayed) or a field to input a ‘Custom’ time interval or compose a message (not displayed). The selection of an alternate time interval transmits a text message indicating the preferred time interval for transmission of the call to occur.

If the initiator of the call [1] confirms [8a] that they are available at the proposed time interval [7], then a phone appointment has been made. The internal time clocks [8a] within the phone [10] of the call initiator and phone [11] of the call recipient [12] are then set. Upon the expiration of the time interval elected [8a] by both participants, the voice call is auto-initiated [9].

The selection [8b] of an alternate time interval replicates the process of scheduling the voice call as in [4b], [6], [7], [8a], [9]. Upon confirmation of a time to call [8a], the internal time clocks are synchronized with the time confirmed. The call is auto-initiated [9] by the phone [10] with the intention of connecting to the recipient's phone [11].

A ring tone indicates that the initiator of the call [1] wishes to connect at the time designated and confirmed [8a] by all participants [1], [12].

FIG. 2

1. Caller adds the intended recipient of a communication to the contact list. The person you wish to communicate with is using the same software application.

2. The call is scheduled with the member of the contact list.

The caller uses the calendar in the communication application to schedule the time at which they would like to have the call. “Now” is the default time.

3. Devices synchronize.

The device on which the call is scheduled transmits data specific to the requested time for the voice transmission to the email address or phone number associated with a software application on another device.

The recipient may choose to either to

4a. Accept; or to 4b. Schedule: Select 5 mins, 10 mins, 15 mins, input custom time interval or to 4c. Dismiss.

If 4a is selected, then the call is connected.

If 4b is selected then time intervals are displayed. The time interval selected is displayed on the recipient's screen. A time interval is selected. The recipient's application syncs with the application of the initiator of the call request. The selected time interval is displayed.

The recipient may also select 4c and dismiss the call.

The initiator may then choose to

5a. Confirm; or 5b. Schedule the call.

Once the time is confirmed;

6. The software applications on each device informs the Internal Time Clocks on each device of the timing for the call.

7. Voice Transmission

Voice transmission is initiated at the confirmed time.

### DETAILED DESCRIPTION OF THE INVENTION

In another embodiment:

Initiator: Schedule the call.

Recipient: Selecting a link to ‘accept’ triggers the call.
Selecting a link to ‘schedule later’ results in the display of options:
   5 mins, 10 mins, 15 mins, custom.

Initiator receives a ‘schedule later’ response from the recipient and selects either:
A: Confirm to set the internal time clock of the device.
B: Schedule later
   Selecting a link to ‘schedule later’ results in the display of options:
   5 mins, 10 mins, 15 mins, custom.

Time set for the call arrives:
Internal time clocks are synchronized.
   Synchronized time clocks display a message on each device:
      the message is an alert that the call is about to commence.

The initiator and recipient can re-schedule using the above process.

If neither party reschedules then the call is initiated at that time.

In another embodiment;

The phones ping each other before initiation of the call.
If the communication devices of either or both participants are occupied the option to reschedule is offered.

In another embodiment, an alert pops up, ‘Call coming up. Still a good time?’

The recipient can also choose to dismiss the request with or without the knowledge of the call initiator.

The invention is in part what happens before the call. The invention includes a pre-calling algorithm. The invention enables the user to input a list of the phone numbers of the people with whom the user wants to speak. The input can be through verbal annunciation of the names of contacts. Calls are then scheduled.
The user can enter the phone number of one person with whom I wish to speak.

Selecting the call icon transmits a text message with links offering the person called the option to accept the call, schedule the call for later or decline the call. If the person who is called selects to accept the call, then a voice connection is made.
If the person who is called selects to schedule the call for a later time, then a wheel with numbers 1-12 and a wheel with ‘am or pm’ is displayed. The call recipient sets a time by selecting a number, am or pm and selects send. The caller receives the message indicating the preferred time for the call to be affected. The caller may confirm the time indicated or select schedule later. The process repeats until a time is confirmed. Two minutes before the connection is made, a message is sent to the intended participants. Also: Inspiring messages. With link to purchase written materials.

Business advice messages: Advertising message with link to purchase: “pay yourself first!‘ ‘Gladwell's new book is available on Amazon’. A link which offers to schedule other activities. Pre-set discussion item reminders for the call are displayed during the call.
The call recipient may also select to decline the call. No further action is then required.
If a list of intended call recipients is entered, the process utilized for a single call is applied to multiple calls. Scheduling, as a function of availability is automated; the algorithm pings the calendar. A ‘to do’ list of intended voice transmissions takes form.

Call suggestions are made. For birthdays. For regular conference calls with multiple participants. For convening impromptu conference calls. The algorithm learns from data inputs.

Features of The Invention includes functionalities such as:

One click to select time of a call. One click to confirm time of a call. The algorithm checks your calendar. The algorithm checks for meetings or block out times. The algorithm checks to see at what times other calls are scheduled. The algorithm tells the user if there is a conflict when they schedule a call. The algorithm, when used by the recipient, tells the recipient if they have a call scheduled for a conflicting time. The algorithm issues a pre-call initiation warning. Otherwise the participants may forget to call. The call is auto dialed at the scheduled time due to the algorithm of the current invention.

The user inputs a list of the people who are intended recipients of a voice call. The calls are set up like a to-do list. Call suggestions are made;

‘Did you need to call [name from list]’′,

Do you need to call someone from your list of [list name];

a self-forming to do list takes shape.

Scheduled activities from a calendar generate a to do list.

A list of calls to be made creates an effective to do list.

The user sees a log of calls made. The user sees calls which did not connect and will roll over.

From a list of scheduled activities, suggestions are made regarding calls participants who the user may wish to call. The user selects the appropriate participant(s). The calls are rescheduled.

Elegance that delights the user:
When someone asks if someone they wish to call is available the request comes with links.
Accept/Schedule/Decline

If the recipient selects ‘Schedule’, a time wheel is displayed.
The recipient may select a time, ‘15 minutes’ for example, and select send.

The first user, who initiated the contact, can select Confirm/Schedule Later.

If the initiator of the call selects ‘Confirm’, the initiator receives a ‘Yes’.

The call is set for auto-dial.

Both users receive a pop-up reminder just prior to the call being initiated by the original initiator's phone. Either party may choose to schedule the call for later.

Actually Connecting
Without auto-dial, how will participants in the call remember that it's time to make the call?

Are they going to keep checking the time even though you get busy doing something else?

They might. But they might miss making the call.

And who is initiating the call now? Is the call initiator calling the intended call recipient at the agreed upon time or . . . is the intended recipient calling the initiator?

The present invention auto-dials:

But first, the present invention sends a reminder to the initiator, and the intended recipient, that the call will be auto-dialed momentarily, unless one of the participants select the/Reschedule/button, which pops up along with the reminder.

Display
The message gets the attention of the intended recipient. The intended recipient sees or hears a notification. Notifications may have a whimsical touch.

The feature sets described may be voice activated. I could say, ‘Call Charles Rosendahl’. The digital personal assistant, such as Siri, Cortana, Echo, Alexa or others, finds ‘Charles Rosendahl’ in contacts. Alternatively, the digital personal assistant search could the search the web or other databases for a number to use to send a voice transmission. The call by the personal assistant constitutes notification in the form of a text message sent to the intended recipient. The purpose of the message is to schedule a call to the intended recipient of a voice transmission.

A user initiating a call transmits a message regarding scheduling of a call: ‘Can you take a call?’

The ‘ring’ is a text or SMS which is used to schedule a call. The message may be sent by any means, such as through a connection made possible by the internet, by telecom companies, by cell phone companies using GSM, CDMA or any other technology.

A message can be data usage on telco network or internet. The phone call can go thru a telco GSM, CDMA or internet. The message can start on one and switch to the other. Timing is based on the confirmed scheduling of the call amongst participants.

If the intended recipient has the application, then the call initiator gets a response by text or artificially intelligent digital personal assistant saying, ‘[Insert Caller's Name], I'm on a call right now. ‘Can we schedule the call for 15 minutes from now?’ Or in another embodiment, ‘can we schedule the call for 10 minutes from now or 20 minutes from now?’ Or a specific time or times is indicated.

The call initiator may select a time indicated. The party who suggested the time for the call receives a message from the call initiator confirming one of the times suggested.

In an embodiment of the present invention in which only one party has the application:

1. The call initiator makes a call to intended recipient. The intended recipient doesn't have the application which is the present invention. The intended recipient is already on a call.

2. The message sent from the intended recipient contains a highlighted link. Or the words ‘press’ or ‘press to schedule’ are displayed. The call initiator selects ‘press’ to elicit a display of time intervals, 10 minutes, 15 minutes, 20 minutes, 30 minutes (in the same way that emoji can be displayed and selected). The preferred time interval is selected and sent to the intended call recipient.

Alternatively, the message sent from the intended recipient is populated with time interval icons; such as [5 minutes], [10 minutes], [20 minutes], [Other]. The call initiator may reply by typing in one of the time intervals indicated, or a type in an interval of their choosing and select ‘send’.

3. The intended call recipient receives a reply, a text message with the preferred time interval indicated. The intended call recipient, who has the application, is offered the choice of confirming that time or sending a message with a link to the call initiator to suggest a different time interval or to reschedule. In this reply, the call initiator may press the time interval displayed to send a ‘confirmation’ or selected ‘reschedule’. If ‘reschedule’ is selected the other time intervals. If they select ‘confirm’, then the time indicated is confirmed by the transmission of a message to the recipient.

4. If the user has the application, a reminder is displayed a few seconds before the attempt for a connection with the intended call recipient is made through the channel for voice transmission. The reminder provides a link allowing for the call to be rescheduled. If there is no intervention, the call is initiated.

5. If the call initiator did not select ‘confirm’ in response to the request to schedule a call, they may select a displayed time interval. The intended recipient then receives a message indicating when the call initiator would like to connect via the voice transmission channel.

In another embodiment of the present invention, the phone number of an incoming call is captured. A response text message is generated by the intended recipient and sent to the initiator of the call. The message says, ‘I'm on a call. Would you like to schedule for later? Select a time!’ Time intervals are presented in the text from which the recipient may select. The user replies by typing in a one of the proposed time intervals and selecting send.

The user does not have to download an application to their phone to use the described features of the present invention. Features and functionalities of the present invention can be utilized by download of an application or through a cloud based application.

A simple way of generating usership of the algorithm is as follows: a call initiator who does not have the algorithm will call someone who does. When the person who has the application is on a phone call, and is called by another caller, a message can be displayed to the party calling in. The content of the message states that if they wish to schedule a call with the intended recipient of their call, that they can use a link to obtain the algorithm providing the functionality of the present invention.

The present invention enables the user to set time blocks during which an auto-reply message selected, or custom written by the user. is displayed to the initiator of a call. In the state of the art, a call goes to voicemail if the user doesn't answer the call. In the case of the current invention, if the intended recipient does not answer, the person initiating the call receives information in the form of a text message. The message can explain that the intended recipient is not taking calls until a specified time or for a specified period. The ‘schedule bot’ then schedules a call with the initiator of the call.

A user sets the application notification setting to a display a text message created by the user as a reply for a specified time. If a call is received during that time period the caller will receive a text reply, such as, “I'm unavailable. Can I call you back in 20 minutes.” The application which is the present invention chooses a time based on the specified time selected by the user and in conjunction with other scheduled calls.

The call initiator is asked in the text reply to confirm or to request that the call be scheduled for at a different time. If the call initiator has the application which is the present invention, a link will appear in the text message which allows the user to select confirm. A link is also provided that allows the user to schedule the call for another time.

If the call initiator is not using the application which is the present invention, the text reply will ask the call initiator to reply confirm or select a different time and communicate their choice by reply text message. Once a time is confirmed, the voice transmission and reception is scheduled. The call initiator receives a reminder several seconds prior to the voice transmission being initiated from their device. A link providing the option to reschedule is also displayed. The intended recipient receives a reminder several seconds prior to the voice transmission being received by their device. A link providing the option to reschedule is also displayed.

The initiator of the call may receive a notification when an intended phone call recipient in the queue is now available. The initiator of the call is notified by text message that the intended recipient is now available. The notification received by the initiator of the call gives them the option to send a request to the intended recipient with links which enable them to select ‘talk now’ or ‘schedule later’.

The invention allows the queuing of calls. Calls which are to be scheduled can be prioritized.

Names are an input. Access of the initiating caller's contact list may be via verbal command to a digital assistant. The bot makes a request via phone to each person named who is on the list in regards to scheduling a call.

In one embodiment, the intended recipient receives periodic requests for engagement in a phone conversation to insure that the recipient notes the request.

A recipient of a request to schedule a call may not respond upon the first request.

A follow up text message is sent such as: ‘Hey, please respond’.

‘Please respond’ to the link asking if the intended recipient of a voice call can accept a call now or if they would like you to schedule a call with the initiator. The bot repeats the notification in time intervals until the call request is dismissed. The bot skips a reminder if there is a time interval during which the initiator of the call is not available to engage in a cal. If the initiator was not available at an interval, then the reminder request for response to the intended recipient of the voice transmission is sent when the initiator is available: ‘Accept now/Schedule later’? In this iteration, or embodiment, the chat bot queries the list of scheduled calls and knows at what times the initiator has other calls scheduled. The ‘schedule later’ link offers options to schedule the call when the initiator does not have another call scheduled.

If the intended recipient of the voice call was not available when a call request was made, a message is displayed to the intended recipient of the voice call.

The message may be a reminder.

Or information is conveyed that the intended recipient is now available and a notice is displayed.

‘Schedule the call now to [Name of Call Initiator or phone number that called]?’ If yes, a message is sent to the call initiator.

The call initiator can confirm/schedule later/decline.

In addition, users can use the scheduling feature to schedule other activities. Such as a ride service. Or the purchase of movie tickets. Or the payment of bills.

All functionalities of the present invention, all embodiments may also be voice enabled. The attempt to establish a communication as per the state of the art is lacking in efficiency because information is not available regarding the availability of the recipient.

Communication is not occurring at a mutually chosen time.

A phone ringing makes a noise. The present invention turns the notification that someone wants to connect with you into information. That information is used to create confirmed phone appointments. Phone appointments wherein the call is initiated by the internal clock of the phone after issuance of an alert that initiation of the call is pending.

Phone appointments which do not have scheduling conflicts with each other or other scheduled events. Phone appointments which are created systematically upon entry of a calling list.

The present invention has many benefits over the state of the art.

If a user sends a text message to schedule a call and the call is scheduled for 30 minutes from ‘now’, then the user is waiting for 30 minutes. If the user needs to call other people, additional calls may be scheduled. That's a lot to keep track of manually.

Not only does the user need to successfully schedule the calls manually, the user must then remember when to place the calls. Making adjustments to the calling schedule is cumbersome. The invention is an algorithm which schedules calls into available time slots, issues call reminders, auto-dials calls to confirmed recipients and auto-reschedules calls when necessary.

In the process of scheduling a call, the initiator asks the recipient when they are available. The times or time intervals for which I already have a call scheduled are not available choices from which I can select. The confirmation will only be allowed if another call is not scheduled for the same time. The call will be initiated at the prescribed time. But because things change, the present invention provides a notification just prior to initiation of the call to both the initiator and the recipient. The notification provides a link enabling either party to reschedule or even cancel the call.

Which brings us to another useful feature of the invention. The length of phone calls can be managed such that a call is scheduled for a specific length of time. What if the user wants to go over? As the time limit approaches, the chat bot asks if the user want to reschedule the next call. The user can indicate no and conclude. Or the user can indicate yes and the bot will query the subsequent intended call recipient(s) to ask them to confirm a time at which the call(s) can be rescheduled.

The user lists the people they want to call and the calls are set up creating a to-do list.

The chat bot also makes suggestions based on my calendar. Or my email's content. Or my text messages. Or other communication medium used by me.

The bot queries the user, ‘Do you need to call Person A?’ How about Person B? Should I schedule a call with Person C?′ and so on. If the user selects ‘Yes’, that person is added to the list. A to do list of calls to make.

Produced for the user: A log of calls made. A log of calls which did not connect and will roll over.

Elegance that delights the user:
When someone asks if the user is available, the request comes with links.
Accept/Schedule/Decline

If the user selects ‘Schedule’, a time wheel is displayed.
The user may select a time, 15 minutes, and select send.

The first user, who initiated the contact, can respond to an intended call recipient who selects ‘Schedule Later’ by selecting ‘Confirm’/Schedule Later’.

If the intended recipient selects “Confirm”, the call initiator receives a ‘Yes’.

If the intended recipient of the call does not want to engage in a call at the time, that participant can select the ‘Schedule later’ link.

The sequence repeats unless someone selects ‘decline’.

The call is set for auto-dial. The chat bot uses a default setting for call length.

Multiple calls can be scheduled without conflict.

In scheduling multiple calls, the chat bot offers the user the option to set call length for subsequent calls or to use the default setting for call length.

Actually Connecting
Without auto-dial, how will the user(s) remember that it's time to make the call?

Are they going to keep checking the time clock even though they become occupied doing something else?

One embodiment of the present invention auto-dials.

But first, the present invention sends a reminder to the user and the intended recipient that the call will be auto-dialed in a few moments, unless the user select the ‘reschedule’ link, which are displayed with the reminder.

Notifications to users are made through a sound, a vibration, and/or light signal.

Notifications may also have a whimsical element, such as a flashing image of the user.

Go to the contact list or dial pad. Calls can go over the internet, or GSM or CDMA.

Services like bandwidth, trulia or infobip provide the connection to the cell of or telecom.

Calling Uses a bot. A bot that queries the intended recipient. A bot that schedules a confirmed call.

While the call initiator is waiting for a reply, the call initiator sends out another inquiry as to someone's availability to take a call. The user may receive a call from both parties with one call occurring while the initiator of the call is on the phone with the other party.

Queuing is an aspect of the invention that resolves this conundrum.

Calling is managed by bots which are software applications which use machine learning to queue calls, plan the length of calls and suggest the scheduling of calls based on tasks which are in your to do list or calendar for example. Through the application of artificial intelligence and machine learning, the software bots learn to manage our calling as described by this invention.

### DETAILED DESCRIPTION of ONE EMBODIMENT

The dial pad generates a text message which enables synchronization of a phone call between the initiator of the call and the intended recipient. An exchange of text messages is used to synchronize the time of the call.

The call may be initiated through any method. Methods may include selection of a contact from a list using a keypad or by dialing the number by selecting numbers on a keypad. A method to initiate a call may include verbal instructions.

Initiation of the call through the method selected by the user generates a text message.

The generation of the text message includes an audible or vibratory motion of the phone which alerts the intended recipient that a message has been received. The text message inquires as to the availability of the recipient for a voice call. A link is displayed allowing the recipient to accept or to schedule the call. If the recipient elects to accept the call, a voice transmission is enabled and the participants may engage in a voice call; the voice transmission is generated and the initiator and recipient speak with each other. If the recipient is busy, they may select to schedule the call for later and choose a time at which the call will auto-dial. The initiator of the communication receives the text from the recipient of the first message with a suggested time for a call with the recipient.

The initiator may confirm or suggest another time via text. The ‘requested time text’ generates either a link to confirm or a link to suggest another time. Once participants confirm a time for the call, the internal time clock of each participant's phone informs a phone call appointment has been generated and will be auto-dialed. The phone's internal time clock is programmed by the confirmation to initiate the voice transmission at the time interval selected for a call to be connected.

If a phone call appointment is established, then a reminder notification in the form of a visual display on the phone screen or audible sound generated by the phone, or both, alerts the caller and the call recipient that the call will be initiated. The caller and/or call recipient can use this ‘reminder’ link to reschedule the call. An automated text message initiated from the caller's phone requests confirmation from the recipient. In another embodiment, the call is initiated by the caller's phone at the scheduled time unless the recipient selects the ‘reminder’ link which is displayed to reschedule.

If in the initial messaging sequence, the initiator of the call does not receive a text response to the inquiry text from the intended recipient, then the initiator of the communication may select for automated text messages to be generated at specific time intervals and sent to the recipient until a response is received or the auto-text generation is cancelled.

The method described is a significant improvement over the state of the art because it enables the initiator of the call and the recipient of a call to confirm a time for the call.

The recipient indicates that they are available to accept a call at that moment or the recipient may choose to engage in a text message exchange intended to result in the scheduling of the call for a mutually agreed upon time. Multiple calls may be scheduled by a caller at different times with different participants. A caller could select to send a ‘schedule later’ text message in regards to a voice transmission. That way no voice mail. No phone tag. By setting up calls at the beginning of the day, for example, those calls are then scheduled with the intended recipients at times confirmed by the intended recipients. wishing to engage in a voice call can schedule calls needed to be made in a day. A caller can enter the calls into a to do list

Another embodiment, Can block out time. Can use specific time dial to schedule.

Any one call may involve multiple participants.

The method described provides information prior to initiation of the phone call regarding availability of the intended recipient. The method described functionally synchronizes the call. The method described is proactive in determining availability and provides the functionality to affect synchronization of a call.

Dial a phone number using the keypad or select a call recipient from a contact list.

Select the call button. This sends a text message to the chosen recipient as opposed to generating a ringtone or vibration from the recipient's communication device intended to engage the recipient in a voice call at that precise moment.

The text message produced when the phone call is initiated is a variation of this question, ‘Are you available to take a call?’

If the recipient selects the ‘accept’ the call link, then connection allowing for a voice transmission is made. If the call is not accepted and the recipient does not reply to the text, then, in one embodiment, a reminder notification will be displayed on the screen of the initiator of the call at various time intervals.

If the recipient does not select the ‘accept’ link then the recipient may respond to the inquiry regarding availability by selecting the ‘schedule’ link which displays times at which the recipient would like to reschedule the call. In one embodiment, what is displayed is a selection of time intervals; 5 minutes, 10 minutes, 25 minutes, or some other time increment. Alternatively, a schedule of specific times can be displayed. A text message suggesting a time or time interval is sent to the initiator of this communication.

The initiator of the call selects a link sending a confirmation text affirming the time. In this method, the dial function provided when a contact is selected from the contact list, or when the dial pad is used, generates and transmits text messages which may be exchanged to designate an agreed upon time for the voice transmission to occur.

Alternate embodiments will use different feature sets to make phone call appointments.

In another embodiment, multiple parties use the functionalities described to set up a group phone appointment.

The system asks if this is the best time to place a call.

If the indication is ‘yes’, the call is made.

Initiation by the Caller

A text message is sent:

‘Can you take a call?’

Urgency can be indicated by various methods. The initiator of the call can select the ‘pound’ or hash mark on the dial pad to indicate that the call is urgent such as by displaying the ‘accept’ link in red.

Response by the Recipient

The recipient may select the link to ‘Accept Now’ or to ‘Schedule Later’. These links are displayed when the data transmission is received inquiring about availability of the recipient to take a call.

Accept Now:

If the ‘Accept’ button is selected the call is transmitted.

Schedule Later: If the ‘Schedule Later’ link is selected, time intervals are displayed from which the recipient can select, resulting in a text message exchange between the caller and the recipient for the purpose of agreeing to a time for a voice call. The voice transmission is automated at the time selected and confirmed.

Selecting, for example, the ‘Please call in 10 minutes’ link from the call later menu sends a text to the initiator of the call.

Confirmation: The recipient of the ‘Are you available for a call?’ text with links, who then selects ‘Schedule later’ is sending a text to the originator of the call. This text displays an option for the initiator of the call to confirm the time interval indicated by the original recipient or an option to schedule the call for later. If the original initiator selects ‘Confirm’ this schedules an alert in 10 minutes which can take the form of audible tone sounded on the calling device of each participant. The audible tone indicates that the voice transmission is now being attempted. If instead of confirming the time indicated by the original recipient, the original initiator selects ‘schedule later’, time intervals are displayed. Selection of a time interval transmits a text message to the original recipient with the indicated time interval. The time indicated can be confirmed or the participant may engage in the same process as described for scheduling a different time interval.

In another embodiment, the caller uses the contact list or dial pad to generate a text that seeks to set a time for a call.

In this embodiment, ‘buttons’ or icons generated by the text messaging serve as links to accept, schedule or confirm.

In another embodiment, the recipient of a text inquiring as to availability to take a call may merge calls.

In another embodiment, the intended receiver may select ‘Accept Now’, ‘Schedule Later’ or ‘Voicemail’. If the recipient selects ‘voicemail’ and the initiator leaves a voicemail message, the voicemail message is converted to text and displayed. The display includes a ‘Schedule later’ link.

The method described synchronizes the time of a call between participants through automated text messages. The voice transmission is auto-initiated upon confirmation of a time, with acceptance now of the call constituting confirmation.

### SUMMARY

The call initiator is asked in the text reply to confirm or to request that the call be scheduled for at a different time. If the call initiator has the application which is the present invention, a link will appear in the text message which allows the user to select confirm. A link is also provided that allows the user to schedule the call for another time.

If the call initiator is not using the application which is the present invention, the text reply will ask the call initiator to reply confirm or select a different time and communicate their choice by reply text message. Once a time is confirmed, the voice transmission and reception is scheduled. The call initiator receives a reminder several seconds prior to the voice transmission being initiated from their device. A link providing the option to reschedule is also displayed. The intended recipient receives a reminder several seconds prior to the voice transmission being received by their device. A link providing the option to reschedule is also displayed.

With the use of the chat bot, the initiation of a phone call provides the caller with information rather than simply making a noise that alerts the intended recipient. The chat bot transmits a text message which asks a question, such as at what time the intended recipient would like the call to be received. Scheduling options can be time intervals, or specific times. One option is for the call to be connected in the present moment.

Calling is managed by bots, applications that use artificial intelligence.

Text or SMS, which comes before the call can be data usage on telco network or internet. Phone call can go thru a telco GSM, CDMA or internet. Can start on one and switch to the other. Timing is based on the confirmed scheduling of the call amongst participants.

As data is collected, machine learning is applied to the algorithm. Artificial intelligence.

Links in the form of application interfaces are provided to functionalize the scheduling of other activities.

Calls may be made from within a calendar.

Displayed on your screen is a message: ‘Jill (the caller's name) wants to schedule a call. Can you talk now? Or Later?’

You hear a chime or feel a vibration. The chime, or vibration, is repeated if there is no response after a few seconds. The message is displayed until you select to accept/schedule/dismiss. The display on the screen replaces the anachronism of the ringing of the phone.

Embodiment that Involves Scheduling with a Calendar

The message inquires as to the availability of the recipient to take a call. The recipient receives the message which is displayed on the screen of the device they are using.

The recipient can indicate that they are available now. The initiator of the sent message receives the data transmitted by the recipient who received the message request indicating that they are available for a voice transmission exchange. Or the recipient receiving the request may indicate that they will be available in 5 minutes, 10 minutes, or some other time interval.

If the recipient indicates that they are available to engage in a call, then they select the ‘accept now’ link. The software applications on the respective devices sync and a call is initiated.

When a message is created with a date & time stamp of ‘now’ (default setting), data is synced with a recipient's device with whom I share software which application. If the recipient has the required software on their device, they see a notification on the screen of their device asking if they would like to schedule a call. The recipient can indicate that they are available to talk now. The recipient can indicate that they would like to schedule a call for later. If the recipient doesn't have the required software, they will be provided a link which enables them to obtain the required software.

Initiation of the Call

The recipient responds. When the message is confirmed voice activation; “call Jill” (name of recipient). The call is initiated. The user says, ‘Schedule a call’. ‘Call Dr. Mark Johnson's office’, call ‘Barbara Schoepf’, call Gina Abel, . . . . Calls are queued and scheduled.

1. A method for scheduling the transmission and reception of voice calls through a text message exchange.

2. (canceled)

3. The method of claim one wherein the availability of the intended recipient of a voice transmission to receive a phone call is determined and the call scheduled.

4. (canceled)

5. The method of claim one wherein a voice transmission is managed such that the scheduling initiation and reception of the voice transmission is coordinated and queued through an automated text messaging exchange.

6. (canceled)

7. The method of claim one wherein the timing of a voice transmission between sender and recipient is synchronized and the call is auto-initiated by one communication device to the other communication device.

8. The method of claim one wherein the timing of a voice transmission between multiple parties is automated and synchronized.

9. (canceled)

10. (canceled)

11. (canceled)

12. (canceled)

13. (canceled)

14. (canceled)

15. (canceled)

16. The method of claim one wherein phone appointments are set and phone calls are scheduled, which includes reminding the initiator and the intended recipient of the scheduled call prior to the appointed call time and enabling the initiator and recipient to reschedule the phone call via a semi-automated text message exchange.

17. The method of claim one wherein internal clocks of multiple devices are coordinated and synchronized to make and receive voice transmissions.

18. The method of claim one wherein the algorithm checks for meetings or block out times for calls.

19. (canceled)

20. (canceled)

21. (canceled)

22. (canceled)

23. The method of claim one wherein activities other than voice transmissions are scheduled.

24. The method of claim one wherein time is blocked out during which the user is not available such that a call is scheduled prior to or after the blocked out time has expired.

25. (canceled)

26. The method of claim one wherein the chat bot queries the calling device of another party to schedule a call, with a voice transmission occurring at the present time being the default time scheduled for the transmission.

27. A method for managing a voice transmission such that the algorithm for scheduling the initiation and reception of the voice transmission which is coordinated through a text messaging exchange is optimized through data obtained through use of the algorithm.

28. The method of claim two wherein the process of participants to schedule a phone call is automated due to machine learning by the algorithm.

29. The method in claim two wherein the algorithm learns from data machine learning to assist in managing the making and receipt of our phone calls through the use of chat bots.

30. The method of claim two wherein a text message exchange is automated such that an appointment for sending and receiving a voice transmissions between participants is scheduled.

31. The method of claim two wherein internal time clocks of devices used to make and receive voice transmissions are coordinated for multiple confirmed phone call appointments.

32. The method of claim two wherein time periods are blocked out on a device used to make or receive phone calls, such that calls are scheduled around the blocked out time.

33. The method of claim two wherein calls are scheduled according to previous call appointments such that calls are queued.

34. The method of claim two wherein the algorithm checks to see at what times other calls are scheduled before scheduling a new call.

35. The method of claim two wherein information useful to scheduling a call is provided as a function of the exchange between the call initiator and the intended recipient of a voice transmission, rather than notification by a ringing noise bereft of information.
